(19) United States
(12) Patent Application Publication
(10) Pub. No.: US 2022/0100543 A1
(43) Pub. Date: Mar. 31, 2022

(54) FEEDBACK MECHANISM FOR IMPROVED BANDWIDTH AND PERFORMANCE IN VIRTUAL ENVIRONMENT USECASES

(71) Applicant: ATI Technologies ULC, Markham (CA)

(72) Inventor: Sonu Thomas, Markham (CA)

(73) Assignee: ATI Technologies ULC, Markham, ON (CA)

(21) Appl. No.: 17/033,266

(22) Filed: Sep. 25, 2020

(51) Int. Cl. G06F 9/455; G06F 9/50; G06T 1/60

(52) U.S. Cl. CPC G06F 9/45558; G06F 9/5077; G06F 2009/45579; G06F 2009/45583; G06T 1/60

(57) ABSTRACT

A method and processing device are disclosed for allocating hardware bandwidth capability for a virtual environment. The processing device comprises memory and a processor. The processor is configured to determine current hardware bandwidth usages for a plurality of virtual functions (VFs) executing on corresponding virtual machines (VMs), determine utilizations of hardware bandwidth capabilities of the VFs, reallocate the hardware bandwidth capabilities based on the determined utilizations and store the reallocated hardware bandwidth usages in a portion of the memory which is accessible to the VMs. Utilizations are determined, for example, based on current hardware bandwidth usages. The hardware bandwidth capabilities are, for example, reallocated by storing metadata indicating the hardware bandwidth capability allocated to each of the VFs.

### BACKGROUND

A virtual machine (VM) is an operating system (OS) or application environment that functions as a virtual computer system with its own virtual hardware (e.g., processor, memory, network interface and storage). In a virtual environment, multiple virtual machines typically run simultaneously on the same physical machine (e.g., host device).

Each VM executes a virtual function (VF), for example, encoding, decoding and gaming, via hardware of the physical machine. The physical machine (e.g., accelerate processing device of a computer) includes a plurality of different types of hardware, each of which is used to execute a specific type of VF. The physical hardware is emulated (e.g., via hypervisor software) to the VMs as virtual hardware to perform VFs on the VMs. The virtual hardware for each VM is mapped to the hardware of the physical machine, enabling the VMs to share the hardware resources of the physical machine.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating example components of a virtual environment platform used to dynamically allocate hardware bandwidth capability to a plurality of VFs according to features of the disclosure;

FIG. 4 is a block diagram illustrating example reallocated hardware bandwidth capabilities written to the hardware bandwidth capability memory shown in FIG. 3. and

FIG. 5 is a flow diagram illustrating an example method of dynamically allocating hardware bandwidth capability according to features of the disclosure.

### DETAILED DESCRIPTION

In conventional virtual environments, each VF is allocated a fixed hardware bandwidth capability (i.e., the hardware bandwidth capable of being provided, by a physical machine, to execute a VF on a VM), which cannot be changed without explicit VM reconfiguration. That is, initially the hardware bandwidth capability for each type of hardware of the physical machine is equally divided among the total VFs. For example, for multimedia video decoding and encoding, although decode/encode hardware has the capability of performing 4 k or 8 k resolution, each VF is allocated a fixed share of the total bandwidth capability of the decode/encode hardware, which may result, for example, in each VF being allocated the bandwidth capability of performing a lesser resolution, such as high definition (HD) resolution. Accordingly, these conventional virtual environment techniques underutilize the capabilities of different types of hardware of the physical machine, resulting, for example, in reduced video quality and inferior visual experience.

Features of the present disclosure include devices and methods for improving the bandwidth capability and performance in virtual environment use cases, such as of multimedia video decoding and encoding. A portion of memory (e.g., metadata buffer) is allocated for storing and providing a measurement of the current bandwidth usage for each VF being executed on a corresponding VM. The bandwidth capability allocated to one or more VFs is dynamically changed (e.g., increased or decreased) based on the overall bandwidth capability for the type of hardware used to perform a VF and the current bandwidth usage stored in the metadata buffer for the VFs.

For simplified explanation purposes, the examples provided herein describe implementing features of the present disclosure for performing multimedia video decoding and encoding VFs. Features of the of the present disclosure can be implemented, however, for any type of virtual environment use case and any type of VF. In addition, bandwidth and bandwidth capability for multimedia video decoding and encoding VFs is defined by a number of macroblocks per second. Features of the of the present disclosure can be implemented, however, using different measurements and parameters for bandwidth and bandwidth capability.

A method of allocating hardware bandwidth capability for a virtual environment is provided. The method comprises determining current hardware bandwidth usages for a plurality of virtual functions (VFs) executing on corresponding virtual machines (VMs), determining utilizations of hardware bandwidth capabilities of the VFs, reallocating the hardware bandwidth capabilities based on the determined utilizations and storing the reallocated hardware bandwidth capabilities in a memory portion accessible to the VMs.

A processing device for allocating hardware bandwidth capability for a virtual environment is provided. The processing device comprises memory and a processor. The processor is configured to determine current hardware bandwidth usages for a plurality of virtual functions (VFs) executing on corresponding virtual machines (VMs), determine utilizations of hardware bandwidth capabilities of the VFs, reallocate the hardware bandwidth capabilities based on the determined utilizations and store the reallocated hardware bandwidth capabilities in a portion of the memory which is accessible to the VMs.

A non-transitory computer readable medium is provided which comprises instructions for causing a computer to execute a method of tiled rendering of an image for display comprising determining current hardware bandwidth usages for a plurality of virtual functions (VFs) executing on corresponding virtual machines (VMs), determining utilizations of hardware bandwidth capabilities of the VFs, reallocating the hardware bandwidth capabilities based on the determined utilizations and storing the reallocated hardware bandwidth capabilities in a memory portion accessible to the VMs.

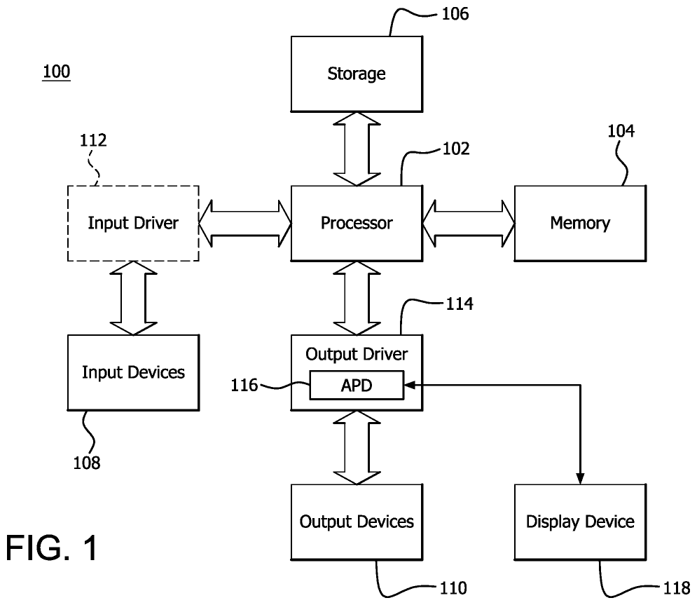

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD 116 accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

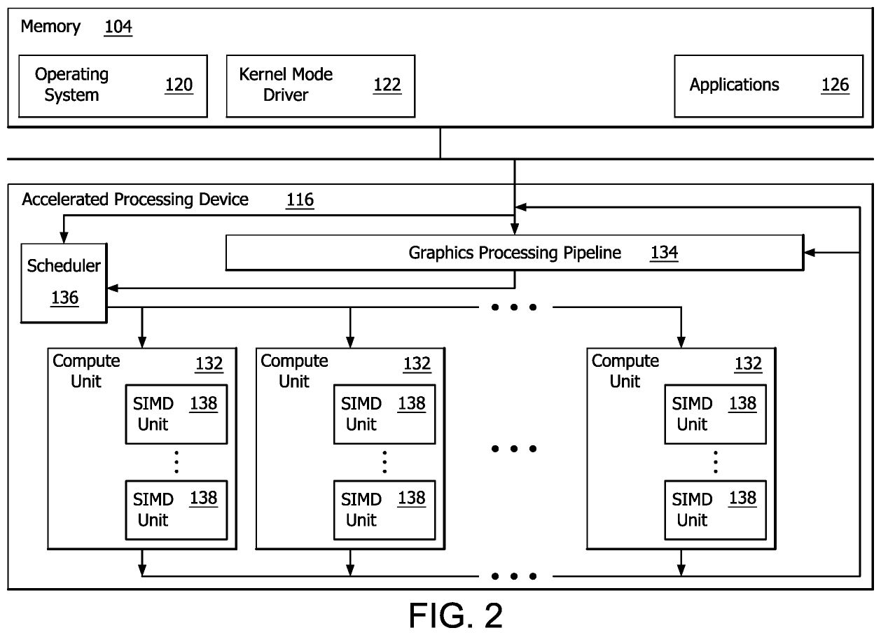

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

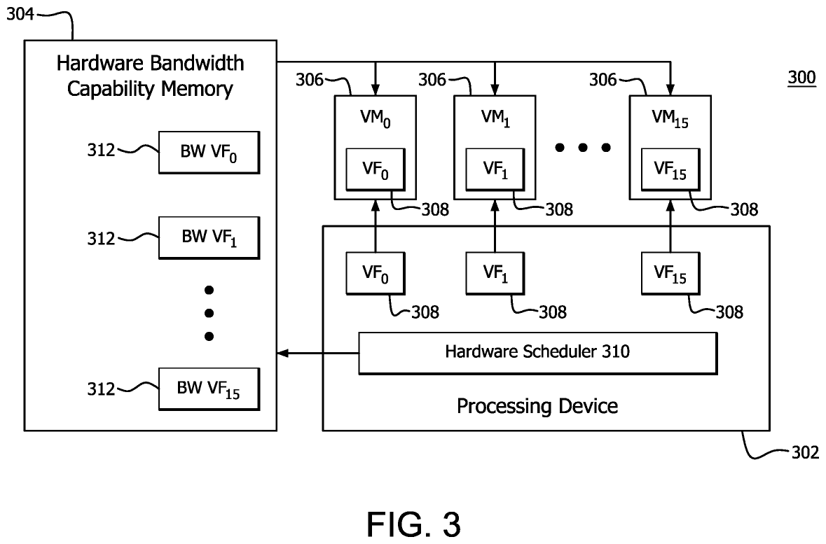

FIG. 3 is a block diagram illustrating example components of a virtual environment platform 300 used to dynamically allocate hardware bandwidth capability to a plurality of VFs 308 according to features of the disclosure.

As shown in FIG. 3, the virtual environment platform 300 includes a processing device 302, a hardware bandwidth capability memory 304 and a plurality of VMs 306 (VM₀ to VM₁₅). In the example shown in FIG. 3, the virtual environment platform 300 includes 16 VMs 306 and 16 VFs 308. The number of VMs 306 and VFs 308 shown in FIG. 3 are, however, merely an example. Features of the disclosure can be implemented for any number of VFs 308 and VMs 306. The VMs 306 are, for example, operating systems or application environments, provided to an end user, which execute a VF 308 (VF₀ to VF₁₅) using physical hardware (e.g., processors, memory, storage and network interface) of the processing device 302. Each VF 308 is, for example, a series of instructions (e.g., programmed instructions) executed by a VM 306 to perform tasks, such as, for example, video encoding and decoding.

The processing device 302 is, for example, the APD 116 shown in FIG. 1. As shown in FIG. 3, the processing device 302 includes hardware scheduler 310. The hardware scheduler 310 is configured to determine, for each VF 308 executing on a corresponding VM 306, the current hardware bandwidth usage for a type of hardware of the processing device 302 that is used to execute a VF 308. The current hardware bandwidth usage for the type of hardware of the processing device 302 is, for example, a number of pixel blocks processed for a time period (e.g., a number of macroblocks per second) or a percentage or portion of an allocated timeslice (e.g., an amount of time, such as milliseconds (ms) or a number of clock cycles) in which the VF 308 is active (i.e., executing) during the allocated timeslice using a type of hardware of the processing device 302.

Based on the determined current hardware bandwidth usage of a type of hardware of the processing device 302 for a VF 308, the hardware scheduler 310 determines whether a portion of the allocated hardware band with capability of a VF 308 is being underutilized (i.e., not using its full hardware bandwidth capability) and the amount of underutilized hardware bandwidth capability or whether the hardware bandwidth capability of a VF 308 is not being underutilized and can benefit from being allocated additional hardware bandwidth capability.

When the hardware scheduler 310 determines that a portion of the allocated hardware bandwidth capability of a first VF 308 is being underutilized and that a second VF 308 is not being underutilized and can benefit from being allocated additional hardware bandwidth capability, the hardware scheduler 310 dynamically reallocates the amount or a portion of the amount of hardware bandwidth capability being underutilized from the first VF 308 to the second VF 308 by decreasing the hardware bandwidth capability for the first VF 308 and increasing the amount of hardware bandwidth capability for the second VF 308 to more efficiently utilize the total hardware bandwidth capability of the APD 116 for a type of hardware.

Although the example shown in FIG. 3 includes the hardware scheduler 310, the functions performed by the hardware scheduler 310 can also be implemented by a microcoder, firmware or any entity which has access to the processing information (e.g., hardware bandwidth usage) of the VFs 308. The functions of the hardware scheduler 310 can be implemented in hardware, software or a combination of both hardware and software.

The hardware scheduler 310 reallocates the hardware bandwidth capability using the hardware bandwidth capability memory 304. The hardware bandwidth capability memory 302 is, for example, a portion of memory 104 shown in FIG. 1, or virtual memory, dedicated to store the hardware bandwidth capability allocated to each of the VFs 308. For example, the hardware bandwidth capability memory 302 is a memory buffer used to store metadata indicating the hardware bandwidth capability allocated to each of the VFs 308 executing on the VMs 306. The hardware bandwidth capabilities are accessible by each VM 306 such that each VF 306 becomes aware of the updated hardware bandwidth capabilities. The hardware bandwidth capabilities are either accessed directly by each VM 306 (e.g., via an operating system of a VM 306 or an application executing on a VM 306) or accessed indirectly (e.g., via a hypervisor).

As shown in FIG. 3, the metadata indicating the hardware bandwidth capabilities allocated to each of the VFs 308 are stored at corresponding addresses of the hardware bandwidth capability memory 304 as indicated by blocks 312. For example, the metadata indicating the hardware bandwidth capability allocated to VF₀ is stored at block 312 indicated as BW VF, the metadata indicating the hardware bandwidth capability allocated to VF₁ is stored at block 312 indicated as BW VF₁ and the metadata indicating the hardware bandwidth capability allocated to VF₁₅ is stored at block 312 indicated as BW VF₁₅.

The total hardware bandwidth capability for a type of hardware is initially divided equally among the VFs 308 in the virtual environment platform 300. The hardware bandwidth capability for each VF 308, is determined, for example using Equation (1) below.

BW_CAP_VF=BW_CAP_{TOTAL}/#_OF_VFs Equation (1)

In Equation (1), BW_CAP_VFx is the hardware bandwidth capability for a VF 308, BW_CAP_{TOTAL} is the total hardware bandwidth capability for a type of hardware of the processing device 302 and #_OF_VFs is the total number of VFs 308 in the virtual environment platform 300.

In this example, the VFs 308 include encoding and decoding of video and the hardware bandwidth capability is measured as a number of macroblocks per second divided by the number of VFs 308, so the hardware bandwidth capability for the hardware used to perform encoding and decoding is initially divided equally among the 16 VFs 308 in FIG. 3 as a number of macroblocks per second divided by 16. For example, the number of macroblocks per second initially allocated to each VF 308 is capable of providing HD resolution.

The number of macroblocks per second divided by the number of VFs is, however, merely an example of the hardware bandwidth capability used to implement features of the disclosure. Other types of hardware bandwidth capability measurements and parameters can be used to implement features of the disclosure, such as, for example, any portion of pixel blocks processed for a time period, a number of frames processed per second (FPS), pixel resolution (e.g., 1980×1280 HD resolution, 4 k resolution or any other resolution) and bitrate (e.g., a number bits per second, such as kbps).

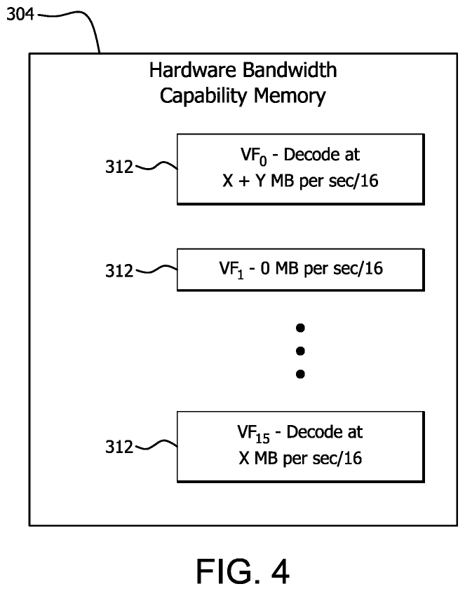

FIG. 4 is a block diagram illustrating examples of reallocated hardware bandwidth capabilities written to the hardware bandwidth capability memory 304 shown in FIG. 3. An example is now described using reallocated hardware bandwidth capabilities examples for VF₀, VF₁ and VF₁₅ and the calculation of the hardware bandwidth capability for each VF 308, as described above in Equation (1). Although the hardware scheduler 310 determines the current hardware bandwidth usage for each VF 308 and can reallocate the current hardware bandwidth capability for each VF 308, for simplification purposes, the current hardware bandwidth usage and reallocated hardware bandwidth capabilities are not described in the example below for VF₂-VF₁₄.

The hardware scheduler 310 determines, for each VF 308, the current hardware bandwidth usage for a type of hardware of the processing device 302 that is used to execute video decoding. For example, the hardware scheduler 310 determines, from the current hardware bandwidth usage for VF₀, that VF₀ will benefit from being allocated additional hardware bandwidth capability. The hardware scheduler 310 also determines, from the current hardware bandwidth usage for VF₁, that VF₁ is not active. The hardware scheduler 310 also determines, from the current hardware bandwidth usage for VF₁₅, that VF₁₅ would neither benefit from having its hardware bandwidth capability decreased or increased.

The hardware scheduler 310 may make this determination by comparing the current hardware bandwidth usage to a utilization threshold. For example, when the current hardware bandwidth usage of a VF 308 is equal to or within a utilization threshold range, the hardware scheduler 310 determines that the VF 308 would neither benefit from having its hardware bandwidth capability decreased or increased. When the current hardware bandwidth usage of a VF 308 is less than the utilization threshold range, the hardware scheduler 310 determines that the hardware bandwidth capability of the VF 308 is being underutilized. When the current hardware bandwidth usage of a VF 308 is greater than the utilization threshold, the hardware scheduler 310 determines that the VF 308 will benefit by increasing the hardware bandwidth capability of the VF 308.

Based on the determined current hardware bandwidth usage for VF₀, VF₁ and VF₁₅, the hardware scheduler 310 reallocates the hardware bandwidth capability or a portion of the hardware bandwidth capability from inactive VF₁ to VF₀ by decreasing the hardware bandwidth capability for VF₁ and increases the hardware bandwidth capability for VF₀ from X MB per second divided by 16 to X+Y MB per second divided by 16 and decreases the hardware bandwidth capability for VF₁ from X MB per second divided by 16 to X-Y MB per second divided by 16. The additional hardware bandwidth capability, can, for example, enable VF₀ to perform 4 k video decoding. In addition, because the hardware scheduler 310 determines, from the current hardware bandwidth usage for VF₁₅, that VF₁₅ would neither benefit from having its hardware bandwidth capability decreased or increased, the hardware scheduler 310 does not change the hardware bandwidth capability of VF₁₅, which remains at X MB per second/16.

The hardware bandwidth capability is reallocated, for example, by changing (e.g., increasing or decreasing) the length of the timeslice allotted to a VF 308 or changing the number of timeslices allotted to a VF 308 for a period of time or clock cycles. For example, the number of MBs per second can be increased for a VF 308 by changing (e.g., increasing or decreasing) the timeslice allotted to a VF 308 or changing the number of timeslices over a period of time or clock cycles.

The hardware scheduler 310 updates (e.g., increases, decreases or maintains) the hardware bandwidth capability for each VF 308 by writing to the memory portions (e.g., addresses) allocated to each VF 308 in the hardware bandwidth capability memory 304. The hardware bandwidth capability memory 304 is, for example, appended to the end of the memory portions in the hardware bandwidth capability memory 304. The hardware bandwidth capability memory 304 is, for example, separate from any other memory portion (e.g., memory buffer). Alternatively, the hardware bandwidth capability memory 304 is part of another memory portion (e.g., memory buffer). For example, the hardware bandwidth capability memory 304 is part of the video encode/decode input and output buffers (e.g., bitstream buffer and YUV buffer).

The hardware bandwidth capability memory 304 is accessed by each VM 306 (e.g., directly accessed via the operating system of each VF or a VM application or indirectly accessed via a hypervisor). Accordingly, each VM 306 becomes aware of its updated (e.g., increased, decreased or maintained) hardware bandwidth capability. For example, in the example described above, because hardware bandwidth capability is accessible to the VF₀ becomes aware of its increased hardware bandwidth capability and switches from streaming HD content to 4 k content.

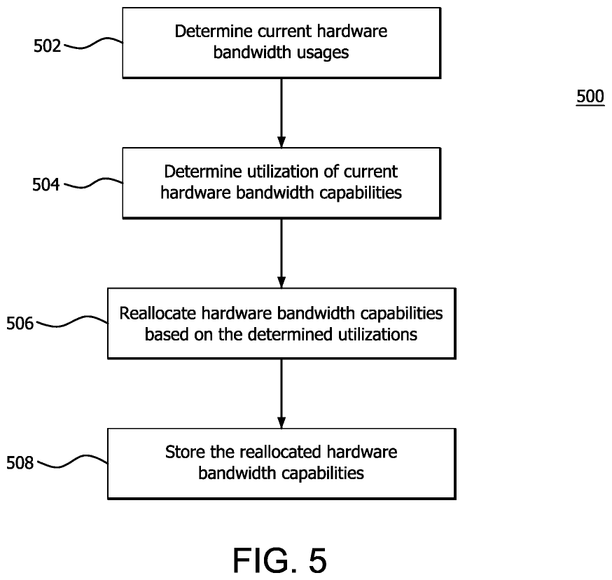

FIG. 5 is a flow diagram illustrating an example method of dynamically allocating hardware bandwidth capability according to features of the disclosure. As shown at block 502, the method 500 includes determining current hardware bandwidth usages for a plurality of VFs executing on corresponding VMs. That is, current hardware bandwidth usages for a type of hardware of a host processing device used to execute the VFs are determined for each of the VFs executing on a corresponding VM. The current hardware bandwidth usage for the type of hardware is, for example, a number of pixel blocks (e.g., MBs) processed for a time period (e.g., a number of MBs per second) or a percentage or portion of an allocated timeslice (e.g., an amount of time, such as milliseconds (ms) or a number of clock cycles) in which the VF is active (i.e., executing) during the allocated timeslice using a type of hardware of the processing device.

As shown at block 504, the method 500 includes determining the utilization of the hardware bandwidth capabilities. That is, a determination is made as to whether or not the allocated hardware bandwidth capabilities are being underutilized for the VFs 308. For example, a determination is made as to whether the allocated hardware bandwidth capability or a portion of the allocated hardware bandwidth capability of each VF 308 is being underutilized (i.e., not using its full hardware bandwidth capability) based on the determined corresponding hardware bandwidth usages of each VF 308 or whether the hardware bandwidth capability of each VF 308 is not being underutilized and can benefit from being allocated additional hardware bandwidth capability. Determining the utilization of the hardware bandwidth capabilities also includes, for example, determining an amount of the underutilized hardware bandwidth capability.

The current hardware bandwidth usages are determined, for example, periodically at equal intervals (e.g., time or clock cycles), upon the occurrence of an event (e.g., an increase or decrease of hardware bandwidth usage of a VF 308 from one or more previous intervals, an amount of increased or decreased hardware bandwidth usage greater or less than a threshold increase or decrease) and upon request (e.g., request from a VF 308 to increase its hardware bandwidth usage).

As shown at block 506, the method 500 includes reallocating the hardware bandwidth capabilities based on the determine utilizations. For example, when it is determined that a portion of the allocated hardware bandwidth capability of a first VF 308 is being underutilized and that a second VF 308 is not being underutilized and can benefit from being allocated additional hardware bandwidth capability, the amount or a portion of the amount of hardware bandwidth capability being underutilized is dynamically reallocated from the first VF 308 to the second VF 308 by decreasing the hardware bandwidth capability for the first VF 308 and increasing the amount of hardware bandwidth capability for the second VF 308 to more efficiently utilize the total hardware bandwidth capability of the processing device.

As shown at block 508, the method 500 includes storing the reallocated hardware bandwidth capabilities in a dedicated memory portion. For example, the hardware bandwidth capabilities are reallocated using a portion of cache memory or virtual memory dedicated to store the hardware bandwidth capability allocated to each of the VFs 308. The hardware bandwidth capability memory is, for example, a memory buffer used to store metadata indicating the hardware bandwidth capability allocated to each of the VFs 308. The VMs 306 are provided the updated (e.g., increased, decreased or maintained) hardware bandwidth capabilities and, therefore, can execute their corresponding VFs 308 according to the updated hardware bandwidth capabilities. The method 500 indicates that the reallocated hardware bandwidth capabilities are stored in a dedicated memory portion (e.g., a memory buffer separate from another memory buffer used to perform other functions). Alternatively, the hardware bandwidth capability memory 304 can also be part of another memory portion (e.g., memory buffer), for example, a part of the video encode/decode input and output buffers (e.g., bitstream buffer and YUV buffer).

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the hardware scheduler 310, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of allocating hardware bandwidth capability for a virtual environment, the method comprising:
determining current hardware bandwidth usages for a plurality of virtual functions (VFs) executing on corresponding virtual machines (VMs);
determining utilizations of hardware bandwidth capabilities of the VFs;
reallocating the hardware bandwidth capabilities based on the determined utilizations; and
storing the reallocated hardware bandwidth capabilities in a memory portion accessible to the VMs.

2. The method according to claim 1, further comprising:
allocating the hardware bandwidth capabilities to the plurality of VFs; and
determining the utilizations of the hardware bandwidth capabilities by determining whether or not the allocated hardware bandwidth capabilities of one or more VFs are being underutilized based on the current hardware bandwidth usages.

3. The method according to claim 2, further comprising:
determining a hardware bandwidth usage of a first VF;
determining a hardware bandwidth usage of a second VF; and
reallocating the hardware bandwidth capability of the first VF and the second VF based on the determined utilization of the hardware bandwidth capabilities of the first VF and the second VF.

4. The method according to claim 3, further comprising:
when it is determined that the hardware bandwidth capability of the first VF is being underutilized and the hardware bandwidth capability of the second VF is not being underutilized, reallocating the hardware bandwidth capability or a portion of the hardware bandwidth capability of the second VF to the first VF by decreasing the hardware bandwidth capability for the first VF and increasing the hardware bandwidth capability for the second VF.

5. The method according to claim 1, wherein the hardware bandwidth capability is a number of pixel blocks for a period of time or clock cycles.

6. The method according to claim 1, wherein the VFs are instructions for executing encoding or decoding video.

7. The method according to claim 1, further comprising:
allocating an equal hardware bandwidth capability to each of the VFs: and
reallocating the hardware bandwidth capabilities by changing the hardware bandwidth capability for one or more of the VFs.

8. The method according to claim 1, wherein reallocating the hardware bandwidth capabilities comprises storing metadata, accessible to each VM, indicating the hardware bandwidth capability allocated to each of the VFs.

9. A processing device for allocating hardware bandwidth capability for a virtual environment, the processing device comprising:
memory;
a processor configured to:
determine current hardware bandwidth usages for a plurality of virtual functions (VFs) executing on corresponding virtual machines (VMs);
determine utilizations of hardware bandwidth capabilities of the VFs;
reallocate the hardware bandwidth capabilities based on the determined utilizations; and
store the reallocated hardware bandwidth capabilities in a portion of the memory which is accessible to the VMs.

10. The processing device according to claim 9, wherein the processor comprises a hardware scheduler configured to determine the current hardware bandwidth usages, determine the utilizations of the hardware bandwidth capabilities, reallocate the hardware bandwidth capabilities and store the reallocated hardware bandwidth capabilities.

11. The processing device according to claim 9, wherein the portion of the memory which is accessible by the VMs is a metadata buffer configured to store metadata indicating the hardware bandwidth capability allocated to each of the VFs.

12. The processing device according to claim 9, wherein the processor is further configured to:
allocate the hardware bandwidth capabilities to the plurality of VFs; and
determine the utilizations of the hardware bandwidth capabilities by determining whether or not the allocated hardware bandwidth capabilities of one or more VFs are being underutilized based on the current hardware bandwidth usages.

13. The processing device according to claim 9, wherein the processor is further configured to:
determine a hardware bandwidth usage of a first VF;
determine a hardware bandwidth usage of a second VF; and
reallocate the hardware bandwidth capability of the first VF and the second VF based on the determined utilization of the hardware bandwidth capabilities of the first VF and the second VF.

14. The processing device according to claim 13, wherein when the processor determines that the hardware bandwidth capability of the first VF is being underutilized and the hardware bandwidth capability of the second VF is not being underutilized, the processor is further configured to:
reallocate the hardware bandwidth capability or a portion of the hardware bandwidth capability of the second VF to the first VF by decreasing the hardware bandwidth capability for the first VF and increasing the hardware bandwidth capability for the second VF.

15. The processing device according to claim 9, wherein the hardware bandwidth capability is a number of pixel blocks for a period of time or clock cycles.

16. The processing device according to claim 9, wherein the VFs are instructions for executing encoding or decoding video.

17. The processing device according to claim 9, wherein the processor is further configured to:
allocate an equal hardware bandwidth capability to each of the VFs: and
the hardware bandwidth capabilities by changing the hardware bandwidth capability for one or more of the VFs.

18. A non-transitory computer readable medium comprising instructions for causing a computer to execute a method of tiled rendering of an image for display comprising:
determining current hardware bandwidth usages for a plurality of virtual functions (VFs) executing on corresponding virtual machines (VMs);
determining utilizations of hardware bandwidth capabilities of the VFs;
reallocating the hardware bandwidth capabilities based on the determined utilizations; and
storing the reallocated hardware bandwidth capabilities in a memory portion accessible to the VMs.

19. The computer readable medium of claim 18, wherein the instructions comprise allocating the hardware bandwidth capabilities to the plurality of VFs and the utilizations of the hardware bandwidth capabilities are determined by determining whether or not the allocated hardware bandwidth capabilities of one or more VFs are being underutilized based on the current hardware bandwidth usages.

20. The computer readable medium of claim 18, wherein reallocating the hardware bandwidth capabilities comprises storing metadata indicating the hardware bandwidth capability allocated to each of the VFs.
